(19) United States
(12) Patent Application Publication
(10) Pub. No.: US 2010/0287623 A1
(43) Pub. Date: Nov. 11, 2010

(54) METHOD FOR DISTRIBUTING A COMPUTER DATA STRUCTURE TO NODES OF A NETWORK

(76) Inventors: Thomas Banik, Erlangen (DE); Markus Erlmann, Nürnberg (DE); Hendrik Gerlach, Erlangen (DE); Reiner Plaum, Erlangen (DE); Bernd Schönmuller, Fürth (DE); Frank Volkmann, Nürnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/519,605

(22) PCT Filed: Dec. 22, 2006
(86) PCT No.: PCT/DE2006/002304

§ 371 Date: Jun. 17, 2009

(30) Foreign Application Priority Data
Nov. 23, 2005 (DE) 102005055871.2

(51) Int. Cl. G06F 9/445; G06F 21/00; G06F 15/16

(52) U.S. Cl. 726/30; 717/177

(57) ABSTRACT

A method for spreading a computer data structure to nodes of a network is provided. The computer data structure has at least one interface for the interaction with the nodes of the network and useful data. After integrating the computer data structure into a first node, the useful data is installed on the first node of the network via the interface. The first node then detects at least one second node of the network. The computer data structure is then transmitted from the first node to the at least one second node. The useful data is then installed on the at least one second node via the interface. The above-mentioned steps carried out for the second node are repeated for a third, fourth etc. node; the third, fourth etc. node correspond to the second node, and the second node corresponds to the first node.

### CROSS REFERENCE TO RELATED APPLICATIONS

This application is the US National Stage of International Application No. PCT/DE2006/002304 filed Dec. 22, 2006 and claims the benefit thereof and is incorporated by reference herein in its entirety.

### FIELD OF INVENTION

The invention relates to a method for distributing a computer data structure to nodes of a network, a computer data structure, a network node, and a network.

### BACKGROUND OF INVENTION

Networks are coalitions of different technical, primarily autonomous systems, in particular computers, but also sensors, actuators, radio technology components etc., such that communication between the individual systems is made possible. The individual systems are designated therein as network nodes or as nodes of the network. Communication takes place via different media, such as e.g. WLAN or LAN.

Networks are also used in the automation engineering field. As such they are part of automation systems that are deployed e.g. for performing process engineering processes. In this case the individual network nodes can perform different tasks or also the same tasks in the automation system. Thus, for example, some network nodes in the automation system perform monitoring functions while others perform control functions. In order to perform the functions, software, such as e.g. firmware, is also installed on the network nodes. In addition so-called agents can be installed on network nodes, e.g. for the purpose of data acquisition and for monitoring the node.

Networks are becoming increasingly more complex. As a consequence commissioning and maintaining the networks is also becoming more complex. Thus, for example, it is necessary from time to time to update the firmware installed on the network nodes or to install new firmware or agents on some network nodes.

According to the prior art the network nodes of a network are accessed individually and directly, from a central point, in order to perform installations or updates of the firmware, the agents or other software. For that purpose the nodes are compiled in a list at the central point. The installation is carried out sequentially (one-to-one) or in parallel (one-to-many) on the basis of said list. Alternatively, according to the prior art, the software components that are to be installed are held in readiness on a central server. By means of a trigger sent to the network nodes or also after monitoring intervals have elapsed in the individual network nodes, the network nodes start checking whether new software components or new updates are present on the central server. If this is the case, a network component begins downloading the software and subsequently installs it. This principle is also known e.g. from the PC sector, where operating system updates can be downloaded over the internet from a central server.

As already mentioned above, the complexity of the networks is steadily increasing. Consequently, a disadvantage of the known prior art methods for installing firmware, agents etc. is that they require very careful maintenance of the network. Thus, for example, the aforementioned list of nodes must always be kept up-to-date, since a node which for whatever reasons is not included in the list also cannot be supplied with new or more up-to-date software. A disadvantage with the use of a central server is that under certain conditions the network may be subject to a heavy load and consequently a temporary degradation of the functional capability of the network will occur if a plurality of nodes, initiated by the trigger, simultaneously downloads the software that is to be installed.

### SUMMARY OF INVENTION

A sensor network is a network which consists of small or, as the case may be, micro computers, known as sensor nodes. The sensor nodes are equipped with sensors and collaborate in order to perform a common task. In such a scheme the sensor nodes typically communicate wirelessly with one another and are also self-organizing. According to the prior art the sensor nodes are deployed in great numbers and over a great area, and monitor their environment until their energy reserves are exhausted. Because of their small size, their favorable price, their use in large numbers, and the autonomy of the sensor nodes, sensor nodes or sensor networks are also referred to as “smart dust”. Self-organizing sensor networks no longer necessarily know the function of each individual network node, but only the function of the overall system. It is particularly problematic in this case to locate all the network nodes in order to update them with new firmware, new agents or other software.

An object of the invention is therefore to provide an improved method for distributing useful data such as, say, firmware, agents or other software to the nodes of a network. Another object of the invention is to disclose an improved computer data structure that is provided for distributing useful data to the nodes of a network. Yet another object of the invention is to disclose improved network nodes or, as the case may be, an improved network.

The objects underlying the invention are in each case achieved by means of the features of the independent claims. Embodiment variants of the invention are set forth in the dependent claims.

A method for distributing a computer data structure to nodes of a network is disclosed by means of the invention. The computer data structure has at least one interface for interacting with the network nodes. Furthermore, the detection of at least one second node of the network is performed from the first node. The computer data structure is transferred from the first node to the at least one second node, where the useful data is installed via the interface. From the second node, at least one third node is determined on which the useful data is also installed following the transfer of the computer data structure from the second to the third node. From the third node, further nodes can then be detected, as described hereintofore for the first, second and third nodes, on which further nodes the useful data is then installed. In this way the distribution of the useful data can be achieved over the entire network, i.e. over all the network nodes, by means of the computer data structure.

The computer data structure is introduced into the network by way of the first node, from where the computer data structure distributes itself essentially autonomously by way of the other network nodes in the network and consequently the useful data is distributed over the network. The method according to the invention has the advantage that a central update server is no longer required. In this way the distribution of the useful data, in other words, for example, firmware or agent updates, can be effected in a complex network such as e.g. a sensor network. A further advantage of the method according to the invention is that precise knowledge of the number and the address of the network nodes to be updated is no longer necessary, since the individual network nodes are detected from a neighboring network node. A further advantage of the method according to the invention is that it can be implemented relatively easily and in a time-saving manner. In principle the computer data structure must be introduced into the network at one point only. Thereafter the computer data structure distributes itself autonomously or in interaction with the individual network nodes in the network.

According to one embodiment variant of the invention, the useful data is executable code which is placed on the nodes by the computer data structure. For that purpose the computer data structure has executable code. The computer data structure therefore serves as a carrier for the useful data that is executable on the nodes and brings with it the code required for installing the useful data (via the interface) on the respective nodes.

According to one embodiment variant of the invention, the computer data structure has a counter. The counter is set to a predefined start value when the computer data structure is introduced into the network. The counter is decremented or incremented on each node which is reached by the computer data structure or on which the useful data is installed, the computer data structure only being transmitted to a further node if the counter is greater or less than an end value. In this case the start value is increased if the end value is greater than the start value. Similarly, the start value is decreased if the end value is less than the start value.

The computer data structure has, for example, a counter, the counter being set to a predefined start value greater than zero when the computer data structure is introduced into the network. The counter is reduced by one on each node which is reached by the computer data structure or on which the useful data is installed, the computer data structure being transmitted to a further node only if the counter is greater than zero. When the computer data structure is distributed, the counter is therefore reduced by one, starting from a start value, each time a new node is reached or each time the useful data is installed on a new node. The computer data structure is transferred from one node to the next node in the network only while the counter is greater than zero. This prevents the computer data structure from circulating endlessly in the network.

According to one embodiment variant of the invention, the computer data structure is, according to the method, stored on the first node if the least one second node is temporarily not accessible, the computer data structure being transmitted to a second node when the at least one second node is accessible once more. In certain situations the individual nodes of the networks may be operated only temporarily rather than continuously. Thus, for example, the nodes in a sensor network are operated only temporarily in order to save energy. The individual nodes are therefore in a waking state or in a sleeping state. In the waking state the nodes perform their assigned tasks, whereas in the sleeping state they perform no tasks. In this context reference is also made to the daily cycle of a sensor node. Assuming the computer data structure resides on the first nodes, and assuming the nodes which can be accessed from the first node are in the sleeping state, the computer data structure is stored according to the invention such that the computer data structure will be transmitted to the further nodes, in other words e.g. to the second node, when the node is once again in the waking state and therefore can also initiate a communication with the first node. In this way it is ensured that the computer data structure also reaches the nodes which can communicate only temporarily with the other nodes of the network.

According to one embodiment variant of the invention, each network node that is provided for interacting with the computer data structure has a docking point, the computer data structure transferring the useful data to the node via the interface and the docking point. The docking point can be implemented e.g. by means of a service via which the useful data can be transferred to the node.

According to one embodiment variant of the invention, the computer data structure has a signature and each node has means for checking the signature. According to the method, the computer data structure is installed on a network node only if the authenticity of the signature has been verified by the means for checking the signature. The docking points of the individual nodes can also be used by harmful data structures such as, for example, worms, in order to install malevolent and undesirable programs on the network node. By checking the signature for authenticity it is ensured that only useful data from a trusted source is installed and consequently executed on the network node.

According to one embodiment variant of the invention, following the detection of the second node it is determined whether the computer data structure has already been transmitted to the second node. If the computer data structure has already been transmitted to the second node, no further transfer of the computer data structure takes place. In this way it is ensured that on the one hand the network is not subjected to load more than is necessary. On the other hand it is ensured, if the aforementioned counter is used in the computer data structure, that said counter is not decremented due to a transmission to a data structure which has already received the computer data structure and consequently that a distribution to network nodes which have not yet received the computer data structure is possibly prevented due to the fact that the counter has reached zero.

According to one embodiment variant of the invention, the data resources of the network node on which an installation of the useful data is planned are checked. If the useful data is unsuitable for the network node and/or installing the useful data on the network node is unnecessary, no installation takes place. This prevents useful data that is by no means needed by a node from being installed on said node and a malfunction of the node possibly resulting therefrom will not occur.

According to one embodiment variant of the invention, the useful data is installed on the network node in order to update an existing application, the installation taking place without an execution of the application on the network node being interrupted. In particular when the useful data is provided for updating an existing application it makes sense to install it in such a way that the network node does not have to interrupt the execution of its assigned task. In this way it is ensured that the update performed does not restrict, even temporarily, the functionality of the network or of the network node.

According to one embodiment variant of the invention, the node has a memory, the application being stored for execution purposes in a first partition of the memory, the useful data being provided for a component of the application that is to be updated, and the component of the application that is to be updated being stored at an entry address, referred to in the following also as the first address (A1), in the first partition of the memory. According to the method, the useful data is stored at a second address (A2) in a second, free partition of the memory. A first jump instruction (J1) is then installed in the memory, the first jump instruction (J1) leading to the first address (A1). In addition, jump and call instructions in the application which lead to the entry address (first address A1) are determined. The determined jump and call instructions are replaced by jump and call instructions which lead to the first jump instruction (J1).

After all references (jumps, calls) to A1 have been redirected via J1, J1 is switched over to A2, with the result that an instant switchover takes place from the old component to the new, current component. As a result of said instant switchover a possibly problematic operation of the old component and the current component in parallel is avoided. Furthermore, in a following step an exchange of all jump and call instructions which now lead to J1 can optionally take place so that the jump and call instructions lead directly to the second address (A2). This enables the detour via J1 to be saved once again. The useful data therefore has only the component of the application that is to be updated. Only what is termed a delta (differential) update is performed whereby the jump instructions that previously led to the component of the application that is to be updated are now redirected to the useful data that is stored in a second address space. In this way it is ensured that the component that is to be updated can be updated while the application is being executed.

According to one embodiment variant of the invention, the entry address for the component that is to be updated is predefined in the computer data structure or is determined by the computer data structure in the application by means of a predefined search method, e.g. using pattern matching methods.

According to one embodiment variant of the invention, the node has a memory and a service manager, the application being stored for execution purposes in a first partition of the memory and the useful data providing a new function of the application. According to the invention, the useful data is stored in a free, second partition of the memory. Furthermore, the new function is registered with the service manager, after which the new function of the application is executable for the node.

According to one embodiment variant of the invention, the node has a memory and the application is stored for execution purposes in a first partition of the memory. The useful data provides a new function of the application. According to the method, the useful data is stored at a second address in a free, second partition of the memory. Furthermore a connection point for the new function in the application is determined, the first connection point being stored at a first address in the first partition. Following this, a first jump is installed from the first address to the second address and a second jump is installed at the end of the second partition back to the address following the first address.

According to one embodiment variant, the useful data is firmware, updates for firmware, agents or killer agents. In this case the killer agents are provided for uninstalling agents on the network nodes.

According to one embodiment variant of the invention, the network is a network of an automation system or a sensor network.

In another aspect the invention relates to a computer program product having computer-executable instructions for performing the method according to the invention.

In another aspect the invention relates to a computer data structure having at least one interface for interacting with the nodes of a network, having useful data and having means for installing the useful data via the interface on a first node of the network. The computer data structure also has means for detecting at least one second node of the network from the first node and means for transmitting autonomously from the first node to the at least one second node. The computer data structure additionally has means for installing the useful data via the interface on the at least one second node and for searching for further nodes from the second node.

In another aspect the invention relates to a network node in a network having a docking point for an interface of a computer data structure, the computer data structure also having useful data. The network node also has means for installing the useful data on the network node and means for sending the computer data structure to other network nodes of the network. In addition the network node has means for notifying a central server of the network, the installation of the useful data on the network node being indicated to the server by means of the notification. In this case the communication between the network nodes in the network is effected via radio-based or line-connected communication links based e.g. on the WLAN, LAN or WIMAX standard.

In a further aspect the invention relates to a network having network nodes and a central server, wherein useful data can be distributed via a computer data structure to the network nodes in the network, wherein network nodes on which the useful data has been installed send a notification to the central server in order to indicate completion of the installation, wherein the server has means for installing the useful data on the network nodes which have transmitted no notification to the central server.

### BRIEF DESCRIPTION OF THE DRAWINGS

Preferred embodiment variants of the invention are explained in more detail below with reference to the drawings, in which:

FIG. 1 shows a block diagram of a network,

FIG. 2 shows a flowchart depicting steps of the method according to the invention,

FIG. 3 shows a block diagram of a computer data structure,

FIG. 4 shows a schematic block diagram of a writable storage medium, and

FIG. 5 shows a block diagram of a network having a central server.

### DETAILED DESCRIPTION OF INVENTION

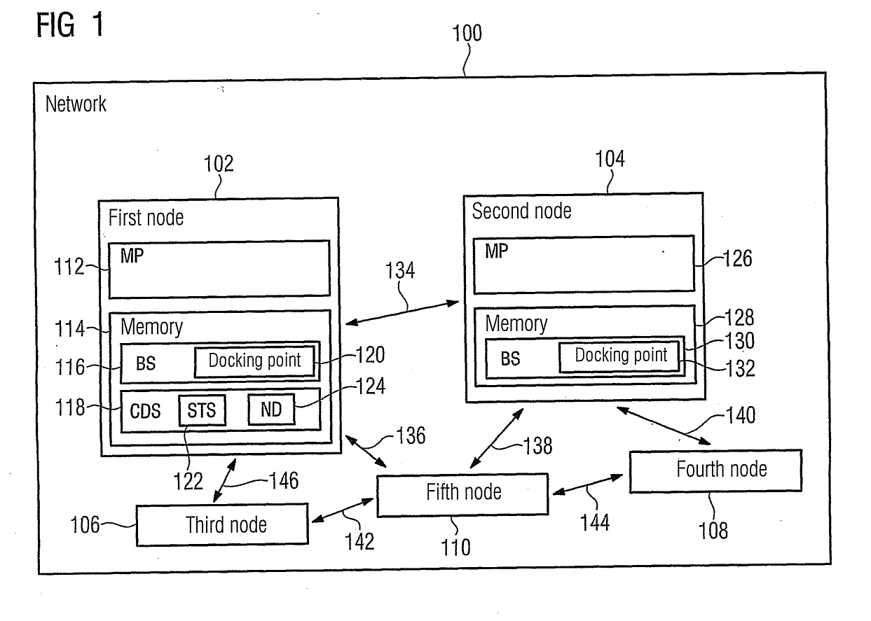

FIG. 1 shows a block diagram of a network 100. The network 100 comprises a first node 102, a second node 104, a third node 106, a fourth node 108 and a fifth node 110. The nodes 102 to 110 are, for example, computer systems or sensor nodes which are connected to one another for the purpose of wireless communication. To that end communication links 134, 136, 138, 140, 142, 144 and 146 are set up between two nodes in each case. The communication links 134 to 146 are WLAN connections for example.

The first node 102 has a microprocessor 112 and a memory 114. The second node 104 has a microprocessor 126 and a memory 128. The third, fourth and fifth nodes 106, 108, 110, also each have a microprocessor and a memory which for reasons of simplicity are not shown here.

An operating system 116 is stored in the memory 114 of the first node 102. The operating system 116 is loaded into the microprocessor 112, e.g. when the first node 102 is commissioned, and executed by it. The operating system 116 serves for example to control the processes executing on the first node 102. The operating system 116 has a docking point 120 for an interface 122 of a computer data structure 118. The computer data structure 118 is fed into the network via the first node 102 and can therefore interact with the operating system 116 via the docking point 120. The computer data structure 118 has useful data 124. The useful data 124 is transferred to the first node via the interface 122 and then installed on the first node 102.

Furthermore, the computer data structure 118 is therein embodied in such a way that from the first node 102 it can detect further nodes, e.g. the second node 104, of the network. Following the detection of the second node 104, the computer data structure 118 is transferred from the first node 102 via the communication link 134 to the second node 104.

An operating system 130 that has a docking point 132 for the interface 122 of the computer data structure 118 is also executed on the second node 104. In this case the operating system 130 is typically of the same type as the operating system 116. The useful data 124 can therefore be transferred by the computer data structure 118 via the interface 122 and via the docking point 132 to the second node 104 and installed on the latter.

From the second node 104, the computer data structure 118 also searches for further nodes of the network 100. For example, from the second node 104 the computer data structure 118 can detect the fourth node 108. Following the detection of the fourth node 108, the computer data structure 118 is transferred via the communication link 140. Upon completion of the transfer, the useful data 124 can be installed on the fourth node 108 in the same way as described for the first and second nodes 102 and 104. From the fourth node 108, the fifth node 110 can then be detected. Following this, the computer data structure 118 is transferred from the fourth node via the communication link 144 to the fifth node 110, where the useful data 124 is likewise installed. From the fifth node 110, the computer data structure can then detect the third node 106 and then reach the third node 106 via the communication link 142. On the third node 106, the useful data is installed via a docking point provided for the interface 122 of the computer data structure by the third node. Thus, after being introduced into the network 100, the computer data structure 118 has distributed itself across all the nodes of the network, with the result that the useful data 104 can be installed on the nodes 102 to 110 of the network.

According to the above-described embodiment variant, the functionality of the initiation of the installation of the useful data and of the searching for further network nodes is implemented in the computer data structure 118. Accordingly, the nodes only need to have one docking point via which the computer data structure 118 can transfer the useful data 124 to the nodes and can then perform the installation of the useful data 124 or at least initiate the installation. Alternatively, however, a corresponding infrastructure for receiving, forwarding and installing the useful data 124 can be set up on the nodes 102 to 110. Then the computer data structure essentially has only the useful data and the interface by means of which it is possible to dock into the docking point.

The useful data 124 can also be an update for the operating systems 116 and 130 for example.

The useful data 124 can also be agents which are installed on the nodes 102 to 110 for the purpose of monitoring the nodes. The useful data 124 can also be a killer agent by means of which an agent already installed on the nodes is uninstalled.

If the nodes 102 to 110 are sensor nodes, then the operating systems 116 and 130 typically part of the firmware and the microprocessors 112, 126 and memories 114, 128 are embedded systems, the memories being writable memories such as RAM, flash memory or EEPROMs. The useful data 124 can therefore also be updates or extensions for the firmware.

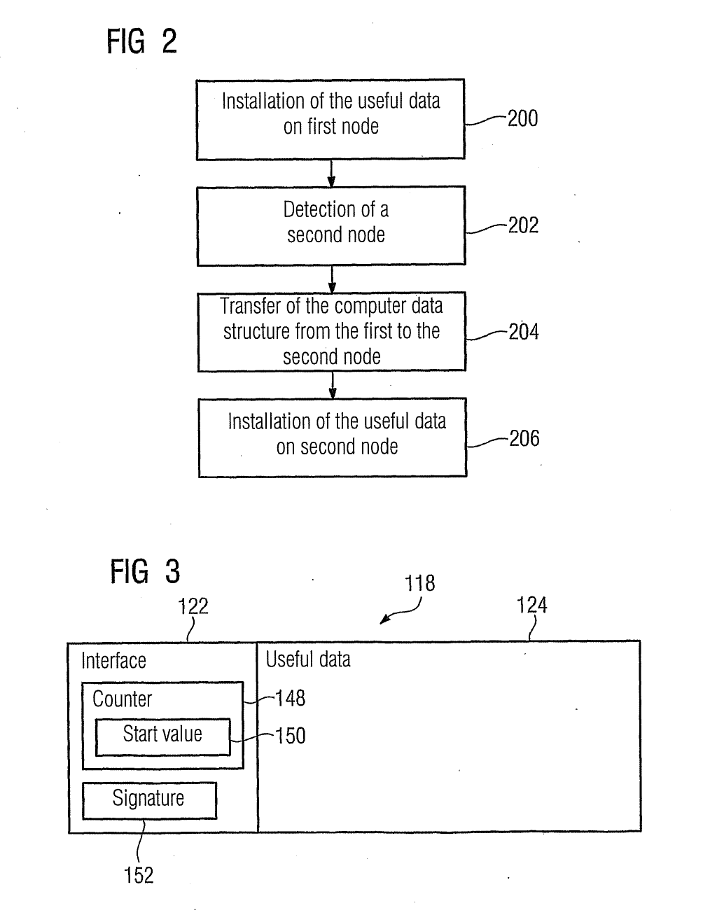

FIG. 2 shows a flowchart which depicts steps of the method according to the invention for distributing a computer data structure to nodes of a network. In this case the computer data structure has at least one interface for interacting with the nodes of the network, and useful data. According to the invention, in step 200 the useful data is installed via the interface on a first node of the network. In step 202, at least one second node of the network is detected from the first node. In step 204, the computer data structure is transferred from the first to the second node. In step 206, the useful data is transferred via the interface to the at least one second node and installed.

FIG. 3 shows a schematic block diagram of the computer data structure 118. As already mentioned previously, the computer data structure has an interface 122 and the useful data 124. In this case the useful data 124 corresponds to the code that is to be installed on the networks, i.e. the code of the software, firmware, agents etc., that is to be installed on the nodes of the network. A counter 148 is integrated into the interface 122. When the computer data structure 118 is introduced into the network the counter 148 is set to a predefined start value 150 which is greater than zero. The counter 148 is decremented by one, for example, on each node which is reached by the computer data structure or on which the useful data is installed. If, for example, the start value 150 corresponds to the number 3 when the computer data structure 118 is introduced into the network 100 (cf. FIG. 1), then taking into account the distribution path of the computer data structure 118 described in FIG. 1, the computer data structure 118 will be distributed only to the second node 104 and to the fourth node 108. Thus, by using a counter which, starting from a start value, is counted down to zero, it is ensured that the computer data structure 118 does not remain in the network infinitely. The computer data structure 118 can also have a signature 152 via which the authenticity of the computer data structure 118 can be checked by the network node.

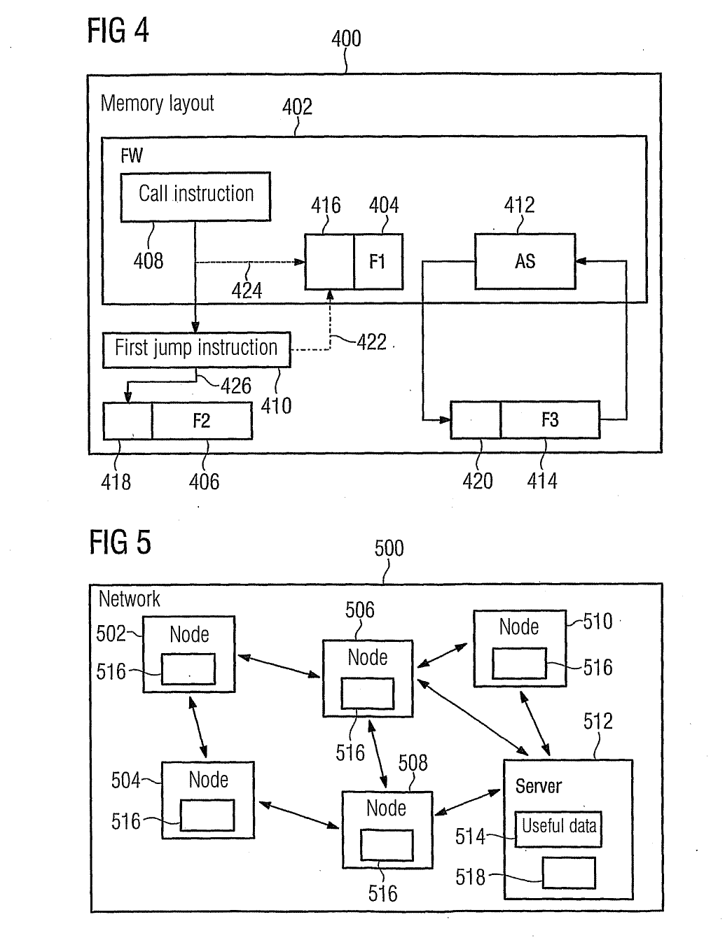

FIG. 4 shows a schematic block diagram of a writable memory 400. The memory 400 can be e.g. a flash memory. Firmware (FW) 402 is stored in the memory 400. The firmware 402 has a first component (F1) 404 which relates e.g. to a function for controlling the network node containing the memory 400. A second component (F2) 406 has been transmitted to the node containing the memory via the computer data structure. The second component 406 relates to an update of the first component 404. In order to update the firmware 402 with the second component 406 the latter is stored at an address 418 in a free partition of the memory 400. A first jump instruction 410 which initially leads to the address 416 (identified by the arrow 422 in FIG. 4) is then installed. All jump and call instructions, such as e.g. the call instruction 408, which lead to an entry address 416 of the first component 404 (identified by the arrow 424 in FIG. 1) are detected in the firmware 402. Thereafter, the determined jump and call instructions are replaced by jump and call instructions which lead to the first jump instruction 410. Accordingly, e.g. the call instruction 408 now no longer points directly to the entry address 416 which leads to the execution of the first component 404, but via the first jump instruction 410 to the address 416, with the result that the first component 404 will still be executed when the call instruction 408 is invoked.

After all the determined jump and call instructions have been replaced, the jump instruction 410 is switched over from the destination address 416 to the address 418 (see arrow 426 in FIG. 1). As a result the first component 404 is now no longer executed, but instead the second component 406, which corresponds to an update of the first component 404, is executed. Optionally, all jump and call instructions which now lead to the first jump instruction 410 can also be replaced by jump and call instructions which immediately lead to the address 418. This means that an update of a first component of the firmware can be performed “on the fly”, with the result that the firmware remains available for its actual function.

A third component 414 which is stored at a different address 420 in a free partition of the memory 400 can also be transferred to the corresponding network node. Furthermore, a suitable connection point (AS) 412 for installation of the third component 414 is determined in the firmware 402, to which connection point the code corresponding to the third component 414 is appended. Following the code corresponding to the third component 414, a return instruction to the address directly after the connection point 412 is inserted.

FIG. 5 shows a block diagram of a network 500 comprising the network nodes 502 to 512, the network node 512 being formed by a central server. According to the method, useful data 514, a copy of which is also stored on the server 512, can be transferred to the nodes 502, 504, 506, 508 and 510 after the computer data structure has been introduced into the network 500 to the individual nodes and installed there. Each node 502-510 has means for notifying 516 the central server 512. As a result of the notification the installation of the useful data on the network node is indicated to the server 512 on the corresponding node. If the server receives no notification from one of the nodes, from node 510 for example, the server can transmit the useful data 514 via installation means 518 to the node 510 and there initiate the installation of the useful data 514.

1.-34. (canceled)

35. A method for distributing a computer data structure to nodes of a network, the computer data structure having an interface for interacting with the nodes of the network and having useful data, comprising:
installing the useful data via the interface on a first node of the network;
detecting a second node of the network from the first node;
transferring the computer data structure from the first node to the second node;
installing the useful data via the interface on the second node;
detecting a third node of the network from the second node;
transferring the computer data structure from the second node to the third node; and
installing the useful data via the interface on the third.

36. The method as claimed in claim 35, wherein the computer data structure has been introduced into the network previously via the first node.

37. The method as claimed in claim 35, wherein the useful data is executable code and wherein the computer data structure additionally has executable code in order to place the useful data on the nodes.

38. The method as claimed in claim 35, wherein the computer data structure has a counter, the counter being set to a predefined start value when the computer data structure is introduced into the network, the counter being decremented or incremented on each node which is reached by the computer data structure or on which the useful data is installed, the computer data structure being transmitted to a further node only if the counter is greater or less than an end value, wherein the start value is increased if the end value is greater than the start value and wherein correspondingly the start value is reduced if the end value is less than the start value.

39. The method as claimed in claim 35, further comprising:
storing the computer data structure on the first node if the second node is temporarily not accessible, wherein the computer data structure is transmitted to the second node when the second node is accessible again.

40. The method as claimed in claim 35, wherein each node of the network which is provided for interacting with the computer data structure has a docking point, wherein the computer data structure transfers the useful data to the node via the interface and the docking point.

41. The method as claimed in claim 35, wherein the computer data structure has a signature, wherein each node has means for checking the signature, wherein the installation of the computer data structure and/or the useful data on a node is initiated only if the authenticity of the signature has been verified by the means for checking the signature.

42. The method as claimed in claim 35, wherein following the detection of the second node it is determined whether the computer data structure has already been transmitted to the second node, and wherein no further transfer of the computer data structure takes place if the computer data structure has already been transmitted to the second node.

43. The method as claimed in claim 35, further comprising:
checking data resources of the node on which an installation of the useful data is planned, wherein, in the event that the useful data is unsuitable for the node and/or the installation of the useful data on the node is unnecessary, no installation of the useful data is performed.

44. The method as claimed in claim 35, wherein the useful data is installed for the purpose of updating an application already present on the node, wherein the installation is performed without interrupting an execution of the application on the node.

45. The method as claimed in claim 44, wherein the node has a memory, wherein the application is stored for execution purposes in a first partition of the memory, wherein the useful data is provided for a component of the application that is to be updated, wherein the component of the application that is to be updated is stored at an entry address in the first partition of the memory, further comprising:
storing the useful data at a second address in a second, free partition of the memory;
installing a first jump instruction in the memory, wherein the first jump instruction initially still leads to the entry address;
determining jump and call instructions in the application in the first memory partition which lead to the entry address;
replacing the determined jump and call instructions by jump and call instructions which lead to the first jump instruction;
switching over the first jump instruction from the entry address to the second address; and
optionally replacing all jump and call instructions which lead to the first jump instruction by jump and call instructions which lead to the second address.

46. The method as claimed in claim 45, wherein the entry address for the component that is to be updated in the computer data structure is predefined or determined by the computer data structure by means of a predefined search method.

47. The method as claimed in claim 44, wherein the node has a memory, wherein the node also has a service manager, wherein the application is stored in a first partition of the memory for execution purposes, wherein the useful data provides a new function of the application, wherein the method further comprises:
storing the useful data in a free, second partition of the memory; and
registering the new function with the service manager, after which the new function of the application is executable for the node.

48. The method as claimed in claim 44, wherein the node has a memory, wherein the application is stored for execution purposes in a first partition of the memory, wherein the useful data provides a new function of the application, wherein the method additionally comprises the following steps:
storing the useful data at a second address in a free, second partition of the memory;
determining a connection point for the new function in the application, wherein the first connection point is stored at a first address in the first partition; and
installing a first jump from the first address to the second address and a second jump at the end of the second partition back to a third address, wherein the third address follows the first address.

49. The method as claimed in claim 35, wherein the useful data is firmware, updates for firmware, agents or killer agents, wherein the killer agents are provided for deinstalling agents on the nodes.

50. The method as claimed in claim 35, wherein the network is a network of an automation system or a sensor network.

51. A computer data structure provided for distributing useful data to nodes of a network, comprising:
an interface for interacting with the nodes of the network;
useful data;
means for installing the useful data via the interface on a first node of the network;
means for detecting a second node of the network from the first node;
means for transmitting autonomously from the first node to the second node; and
means for installing the useful data via the interface on the second node and for searching for further nodes from the second node.

52. The computer data structure as claimed in claim 51, wherein the useful data is executable code and wherein the computer data structure additionally has executable code, wherein the useful data are placed on the nodes by the executable code.

53. The computer data structure as claimed in 51, wherein the computer data structure has a counter, the counter being set to a predefined start value when the computer data structure is introduced into the network, wherein the counter is decremented or incremented on each node which is reached by the computer data structure or on which the useful data is installed, wherein the computer data structure is transmitted to a further node only if the counter is greater or less than an end value, wherein the start value is increased if the end value is greater than the start value and wherein correspondingly the start value is decreased if the end value is less than the start value.

54. A network node in a network, comprising:
a docking point for an interface of a computer data structure, wherein the computer data structure additionally has useful data,
means for installing the useful data on the network node,
means for sending the computer data structure to other network nodes of the network.
